(19) United States
(12) Patent Application Publication
(10) Pub. No.: US 2002/0143560 A1
(43) Pub. Date: Oct. 3, 2002

(54) Seamless, autonomous introduction of new goods and services into dynamic information economy

(75) Inventors: James E. Hanson, Yorktown Heights, NY (US); Jeffrey Owen Kephart, Cortlandt Manor, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/821,281

(22) Filed: Mar. 29, 2001

(51) Int. Cl. G06F 17/60

(52) U.S. Cl. 705/1; 705/26

(57) ABSTRACT

A method, system, apparatus, and computer program product for exchanging products (goods and services) in a non-centralized exchange system is provided. In one embodiment, a matchmaker registers with at least one of a plurality of directory services in the non-centralized exchange system. The matchmaker receives advertisements in a matchmaker determined informational format from a plurality of vendor agents. The plurality of vendor agents obtain the identity and contact information of the matchmaker from one of the directory services with which the matchmaker has registered. A consumer agent obtains the identity and the contact information for one or more matchmakers from at least one of the directory services with which the matchmakers have registered. The consumer agent chooses and receives a list of advertisements from the matchmaker for products that are of interest to the consumer agent. The consumer agent sends a request for a quote to one or more of the vendor agents corresponding to advertisements in the list of advertisements. The consumer agent then receives responses from one or more of the vendor agents to which a request for a quote was sent. From the responses, the consumer agent selects one vendor from which to complete a purchase of the product.

### BACKGROUND OF THE INVENTION

1. Technical Field

The present invention relates generally to methods of business and, more particularly, to methods of matching consumers with sellers in a non-centralized system.

2. Description of Related Art

In an economy of independent autonomous or semi-autonomous software agents, it is desirable to design the system such that any agent may at any time change the goods and services that it offers, either by adding new ones, modifying existing ones, or removing ones. New agents may come into being at any time, and may themselves offer new goods and services. Extant agents may cease to operate. The system needs to be able to adapt to all of these changes without requiring extensive (or even better, any) human interaction.

In the prior art, solutions to bringing potential buyers and sellers together have been global or “systemic” solutions. There are centralized and distributed versions; predefined or self-organizing; and fixed or adaptive variations of these solutions. However, each solution assumes the existence of a common “registry” of what items are available. The assumption is that an agent asks the “system” for a good or service, and the system returns a comprehensive list of all extant suppliers. Sometimes the system even selects a particular supplier for the customer. If the registry is stored by an agent, the registry agent holds a special place in the system (e.g., competing registries are not imagined). Typically, registries are organized according to trade or industry type. This system, however, limits both buyers and sellers from discovering other potential trading partners since some potential trading partners may register with a registry serving an industry for which a buyer or seller may not think to look in locating a trading partner.

In a decentralized economy, there is no prescribed central or global registry containing a complete list or ontology of available goods and services. Therefore a system for new goods & services to be “registered”, i.e., for information about them to be may available to potential buyers, which does not require such a registry would be desirable.

### SUMMARY OF THE INVENTION

The present invention provides a method, system, apparatus, and computer program product for exchanging products in a non-centralized exchange system. All of the entities (matchmaker, vendor, consumer) are autonomous or semi-autonomous software agents. In one embodiment, a matchmaker agent registers with at least one of a plurality of directory services in the non-centralized exchange system. The matchmaker receives advertisements in a matchmaker determined informational format from a plurality of vendor agents. The plurality of vendor agents obtain the identity and contact information of the matchmaker from one of the directory services with which the matchmaker has registered. A consumer agent obtains the identity and the contact information for the matchmaker from one of the directory services with which the matchmaker has registered. The consumer agent chooses and receives a list of advertisements from the matchmaker for products that are of interest to the consumer agent. The consumer agent sends a request for a quote to one or more of the vendor agents corresponding to advertisements in the list of advertisements. The consumer agent then receives responses from one or more of the vendor agents to which a request for a quote was sent. From the responses, the consumer agent selects one vendor from which to complete a purchase of the product.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system in accordance with a preferred embodiment of the present invention;

FIG. 3 depicts a block diagram illustrating a data processing system in which the present invention may be implemented;

FIG. 4 depicts a block diagram illustrating a consumer-vendor matchmaking system in accordance with a preferred embodiment of the present invention;

FIG. 5 depicts a flowchart illustrating an exemplary consumer process for discovering a product or service from a vendor via matchmaking system in accordance with a preferred embodiment of the present invention;

FIG. 6 depicts a flowchart illustrating an exemplary vendor process for selling a product or service via matchmaking system in accordance with a preferred embodiment of the present invention; and

FIG. 7 depicts a flowchart illustrating an exemplary matchmaker process for matching consumers with vendors in accordance with a preferred embodiment of the present invention.

### DETAILED DESCRIPTION OF THE PREFERRED EMBODIMENT

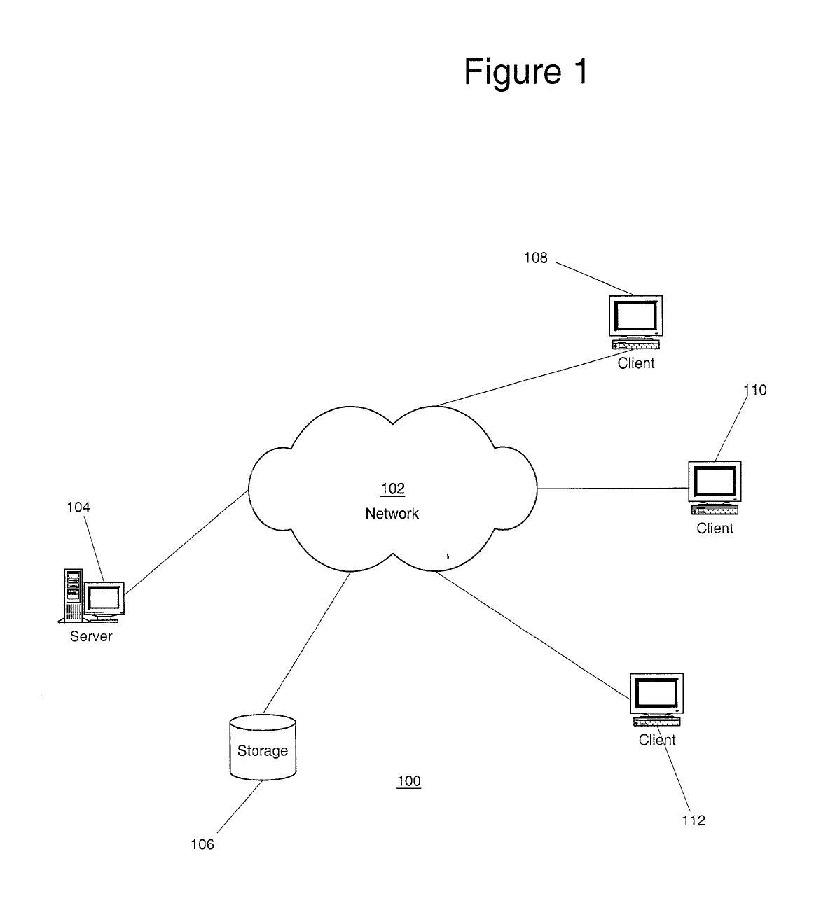

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients; 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

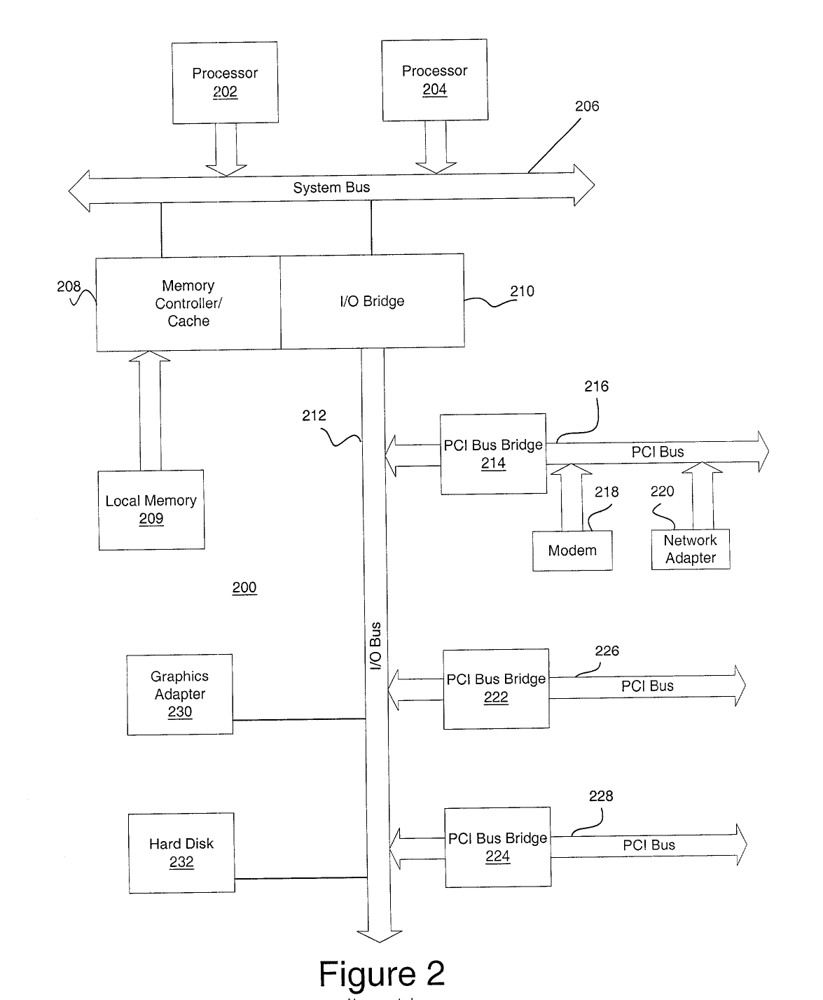

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. 1/0 bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228., from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

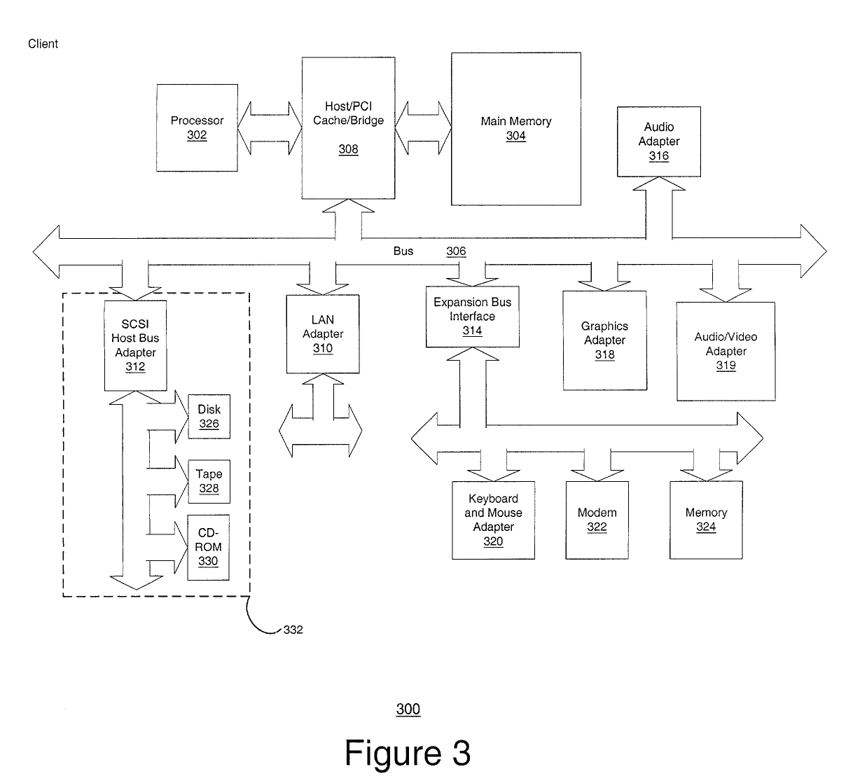

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

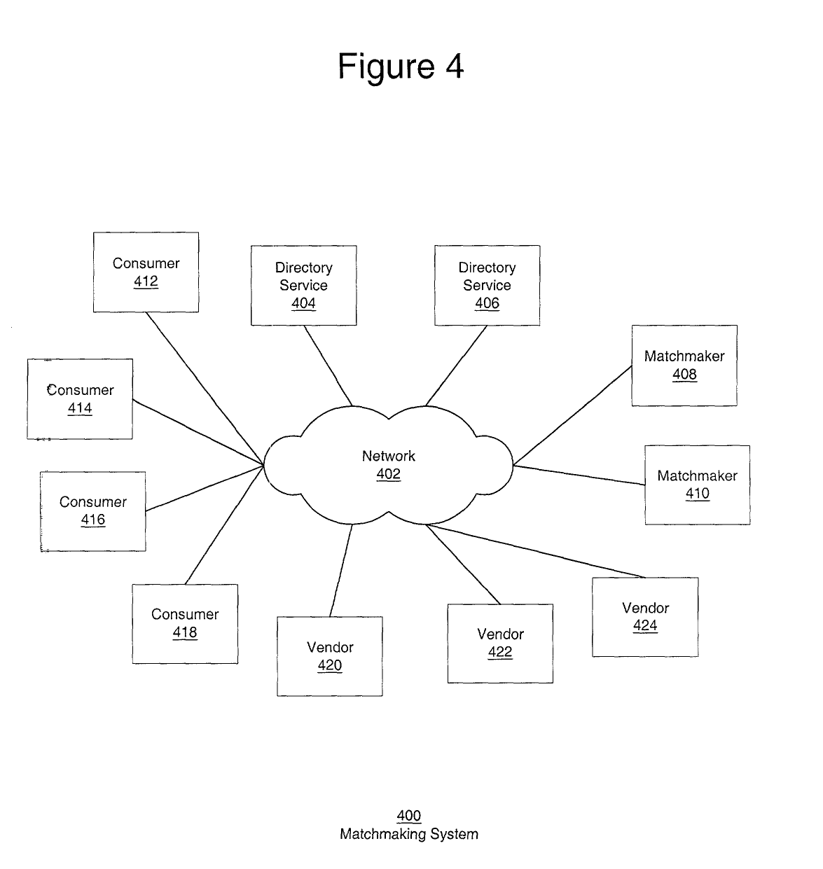

With reference now to FIG. 4, a block diagram illustrating a consumer-vendor matchmaking system is depicted in accordance with a preferred embodiment of the present invention. Matchmaking system 400 provides a method and system in which agents may unilaterally introduce new goods and services (or modifications), and potential customers may learn of them, without requiring a common centralized registry. The matchmaking system 400 also enables agents (both buyers and sellers) to discover a wider variety of trading partners because the matchmakers may register with registries that an agent would not otherwise find, but that would be found by potential trading partners that would not otherwise find a registry that the agent would have registered with. Thus, the present invention matches agents (vendors) providing goods or services with agents (customers) desiring such goods or services. The system 400 of the present invention utilizes the following modules or agents (described as “roles”): consumers 412-418, vendors 420-424, and matchmakers 408-410, each interacting through network 402. Network 402 may be implemented as, for example, network 102 in FIG. 1, and each of consumers 412-418, vendors 420-424, and matchmakers 408-410 may be implemented as one of clients 108-112 or server 104 in FIG. 1. A service matchmaker 408-410 may be a matchmaker for goods or services or both. Furthermore, a given agent may take on any of the different roles, in any combination, at any time. For example, an agent might be a vendor of one set of services and a consumer of others, or an agent might be both matchmaker and vendor; or agents might change roles from time to time; etc. Also, a given vendor may offer any number of distinct goods & services, and may take out any number of ads with any given matchmaker (e.g., it may take out a different ad for each of the services it offers, or it may take out a single ad identifying several services).

Consumers 412-418 purchase goods or services from other agents within the system 400. Vendors 420-424 are agents that offer goods or services for purchase by other agents 412.418. Matchmakers 408-410 are agents that assist vendors 420-424 and consumers 412-418 in discovering and selecting each other, thus matching a consumer 412-418 with a vendor 420-424. Each agent 408-424, whether a matchmaker, vendor, or consumer as alluded to above, is a data processing system acting at the behest of a human “owner.” The agent's interactions with its owner may take on any form or degree of autonomy—i.e., the owner may preprogram the agent's routine actions such that the owner needs to interact with the agent often, seldom, or never. Each agent is operating within a network environment 402 that allows agents 408-424 to send messages to each other, such as, for example, via http, TCP/IP, SOAP, etc. One agent 408-424 may initiate communication with another agent 408-424 if it has appropriate information about the other agent 408-424, such as the other agent's “agent locator” which is analogous to an e-mail address, URL, or telephone number. This communication system is referred to as a “messaging subsystem.” Also, each agent 408-424 may obtain an agent locator for other agents 408-424 from an agent or service referred to as a “directory service” 404-406 analogous to a telephone directory.

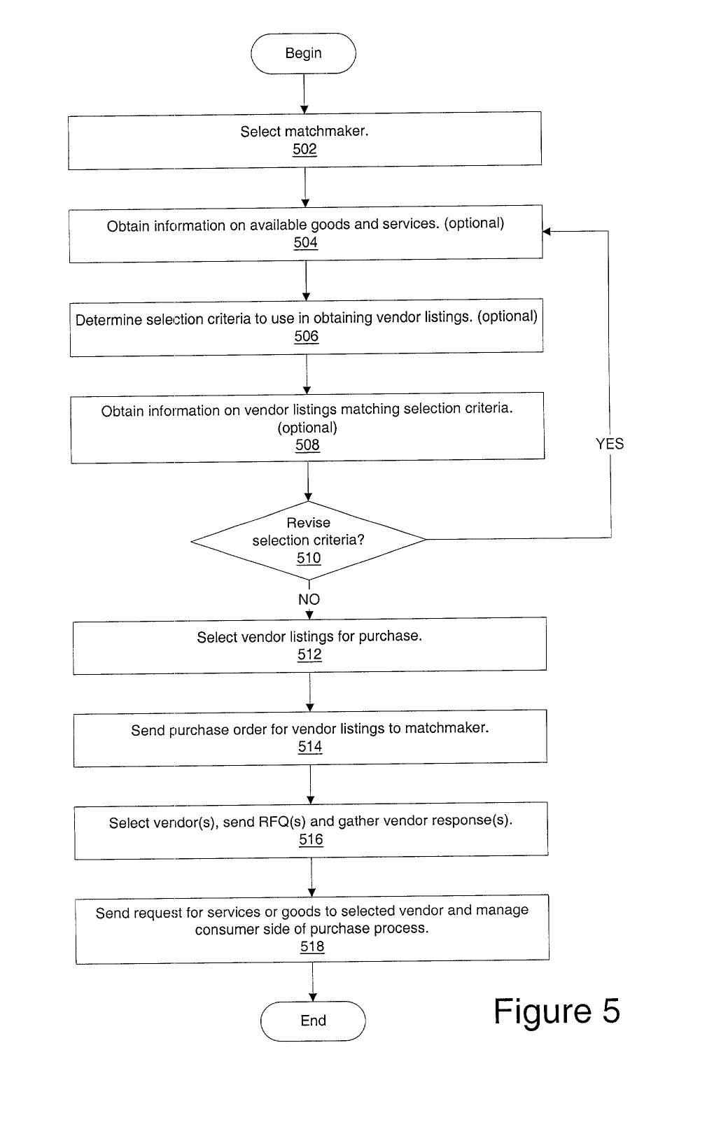

With reference now to FIG. 5, a flowchart illustrating an exemplary consumer process for discovering a product or service from a vendor via matchmaking system 400 is depicted in accordance with a preferred embodiment of the present invention. A consumer agent, such as consumer 418 in FIG. 4, desiring to purchase services through a matchmaking system first selects one or more matchmakers (step 502). The matchmaker listings could be obtained, for example, from one or more directory services, such as, for example, directory services 404 or 406 in FIG. 4, either every time a matchmaker is selected or from time to time as appropriate. If the matchmaker requires a subscription, the consumer agent decides whether to subscribe and manages the subscription process from start to finish.

The consumer agent then optionally obtains from the matchmaker information on what goods/services are available for purchase from vendors (step 504). This may be done by searching, browsing, or downloading the matchmaker's category information (i.e. the matchmaker's ontology of goods and services) along with information about categories for which the matchmaker has listings, if category information is available; by specifying keyword search terms; or by specifying other criteria for selecting goods and services. The consumer agent may optionally present an interface to its owner for searching, browsing, or otherwise obtaining this information, or it may obtain the information without recourse to owner input by, for example, executing instructions previously specified.

After obtaining information about available goods and service, the consumer agent then specifies selection criteria that will be used by the matchmaker in determining which vendor listings to offer to the consumer (step 506). This specification might include specification of goods and services from the matchmaker's category information, if available, such as category names, keyword search terms or other search criteria. It may also include keyword search terms or other search criteria to be applied to vendor listings themselves. The consumer agent may optionally present its owner with an interface for specifying these selection criteria. Alternatively, the consumer agent may make choices as to the selection criteria without resort to presenting the user with options. This may be performed, for example, using options previously selected by a user thus minimizing any human owner's interaction in the process.

The consumer agent then optionally obtains summary information or extracts other information about vendor listings that match the specified selection criteria (step 508). This information, provided by the matchmaker, may consist of extracts of vendors' listings, summary information such as the number of vendor listings matching the search criteria, fees for obtaining the matching vendor listings, or other information. However, in the case where the matchmaker is charging a fee for providing vendor information to consumers, it will not contain agent locators or other information that would permit the consumer agent to immediately contact vendors. The consumer agent optionally presents this information to its owner.

Once the consumer agent has received the information about vendor listings, it determines whether to revise the selection criteria originally specified in step 506 or continue with the transaction (step 510). It optionally does this by presenting an interface to its owner, or makes the determination autonomously based on criteria previously specified, such as, for example, a threshold in the desired number or total cost of vendor listings reported as matching the selection criteria. If the determination is made to revise the selection criteria, the consumer agent returns to step 504. If the determination is made not to revise the selection criteria, then the it continues to step 512.

The consumer agent then chooses, from among the vendor listings matching the selection criteria, a set of vendor listings to purchase (step 512). This may be done by presenting a selection interface to the owner, or may be done autonomously based on criteria previously specified, such as, for example, a threshold in the desired number or total cost of vendor listings to purchase. The consumer agent then sends a purchase order for the selected vendor listings (step 514). Once the listings of vendors are obtained, the consumer optionally selects one or more vendors from the listings and sends each a “request for quote” (RFQ), and gathers vendor responses (step 516). The consumer agent or owner then selects a vendor and a request for service is sent to that vendor by the consumer (step 518). The consumer then manages the consumer side of the purchase process from start to finish.

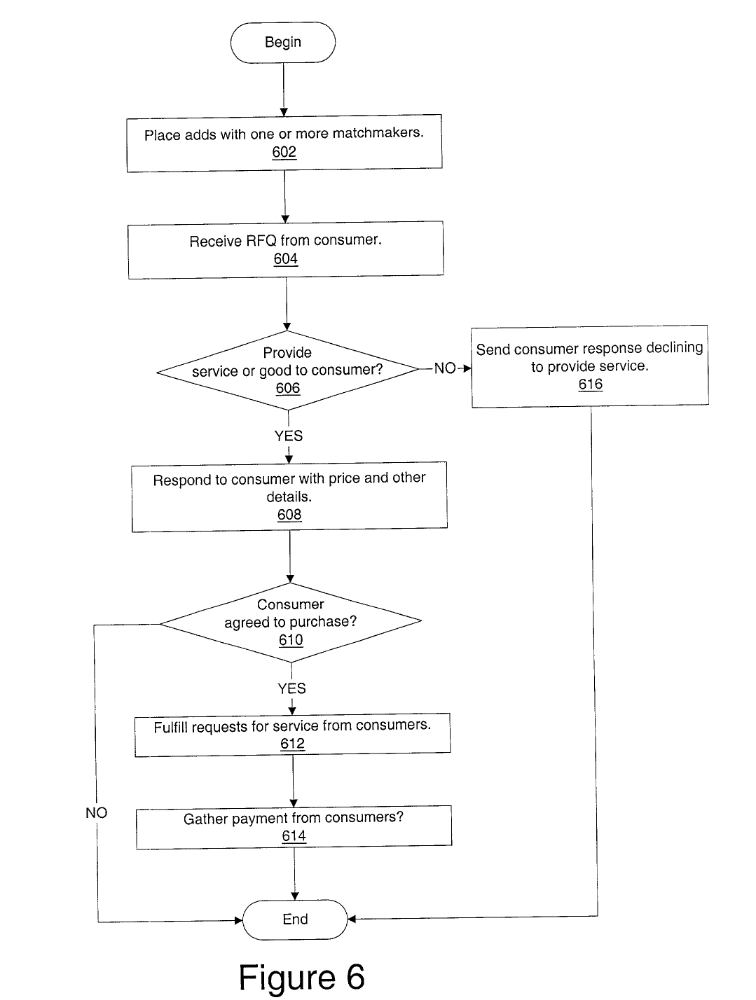

With reference now to FIG. 6, a flowchart illustrating an exemplary vendor process for selling a product or service via matchmaking system 400 is depicted in accordance with a preferred embodiment of the present invention. To begin, a vendor, such as vendor 422 in FIG. 4, places advertisements with one or more matchmakers (step 602). The matchmaker listings to which the vendor places advertisements could be located, for example, using a directory service or services, such as, directory services 404-406 in FIG. 4. The number and identity of the matchmakers used could be determined by the vendor based on cost, matchmaker properties (e.g., the service ontology it uses, its reputation, the number of consumers that use the matchmaker service, etc.), and other factors. The contents of the advertisements are determined both by the matchmaker's required advertisement format and the information the vendor wishes to advertise. It is important that the vendor identify which services it offers.

Once the advertisement has been placed, the vendor waits for requests for quotes to be received from consumers (step 604). When a request for a quote has been received, the vendor decides whether to provide the service or good to the consumer (step 606). Optionally, this may involve negotiation or be based on how busy the vendor is, or characteristics of the consumer, such as reputation or previous experience. If the decision is made not to provide the service or good to the consumer, then the vendor sends the consumer a response declining to provide the good or service (step 616). If the vendor decides to offer to provide the good or service to the consumer, then a response is sent to the consumer with (e.g.) price and/or other details of the offer (step 608). The vendor then awaits a response from the consumer. Once the response is received, the vendor determines whether the consumer has agreed to or declined to purchase the service or good offered (step 610). If the consumer declines to purchase, then the process ends. However, if the consumer agrees to purchase the offered service or good for the terms indicated by the vendor, then the vendor fulfills the request from the consumer (step 612) and gathers payment from the consumer (step 614).

Although described in terms of a fixed fee, one of ordinary skill in the art will recognize that other fee arrangements may be used as well. For example, the vendor agent and consumer agent may negotiate the fees or the fee may be based on characteristics of the consumer, such as, for example, the consumer's reputation. The vendor and consumer may carry on any sort of negotiation prior to the consumer making the selection of a vendor. Furthermore, the details of the payment may take on any form, such as, for example, pay in advance, pay afterward, or pay-as-you-go.

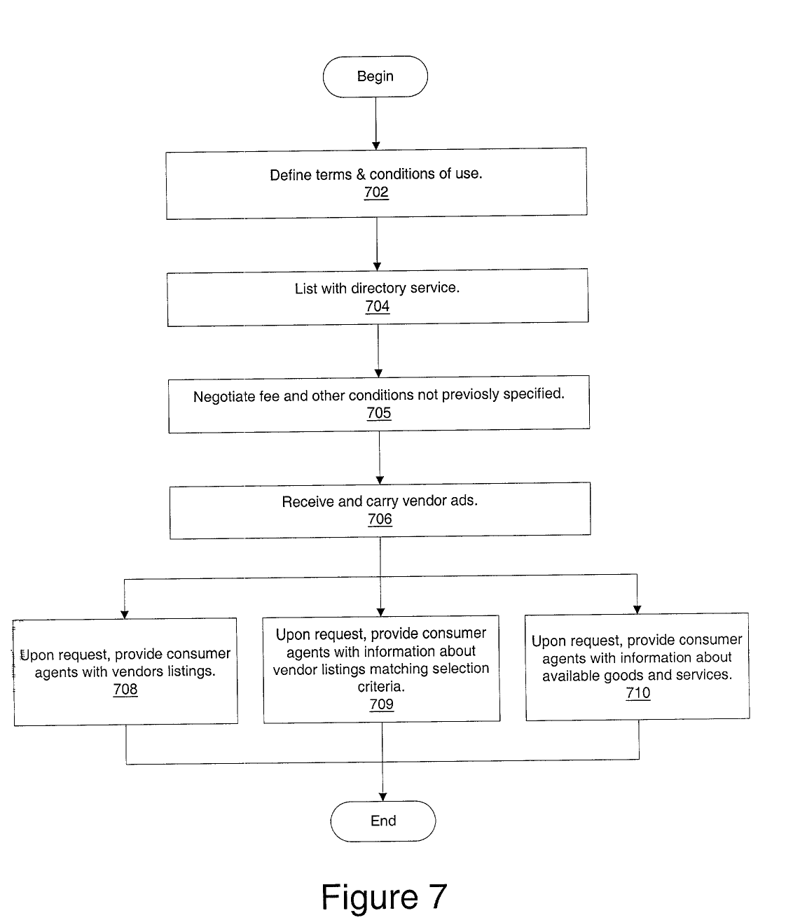

With reference now to FIG. 7, a flowchart illustrating an exemplary matchmaker process for matching consumers with vendors is depicted in accordance with a preferred embodiment of the present invention. Service matchmakers, such as matchmaker 408 in FIG. 4, act in many ways like an automated online classified ad paper. Each service matchmaker defines its own terms and conditions, both for placing advertisements and for searching listings (step 702). For example, some service matchmakers may use a subscription model, some may be fee-per-use, and some may be free. Furthermore, the fee may be obtained from the vendors, from the consumers, or from both. Fees and other terms & conditions for both vendors and consumers may also be negotiable on an individual basis, or may change from time to time. Each service matchmaker defines its own ontology of goods and services and its own vendor listing format. Also, rather than having a predefined (e.g. human-crafted) ontology, each matchmaker may permit vendors to propose items. The service matchmaker may also incorporate advanced searches, data mining technologies, or other “intelligence” to provide better service to consumers. Matchmakers may also choose to specialize in some particular industry, crafting their vendor listing to suit that industry.

Once a service matchmaker has defined the general terms and conditions of use, the matchmaker lists itself with one or more directory services (step 704), such as, for example, directory service 404 in FIG. 4. The matchmaker's listing with the directory service may contain information on how vendors and customers can communicate with it, its general terms and conditions, etc. The exact fee or other terms and conditions not previously specified in step 702 may be negotiated separately for each vendor or listing (step 705). The service matchmaker then receives and carries vendor advertisements (step 706). The matchmaker may receive the vendor advertisements, for example, through XML messages via http, electronic mail (e-mail) or through an on-line form on a Internet web page filled out by the vendor. The vendor advertisements may be carried, for example, for a fee, for a limited time, or both. The terms to the vendor may also include a combination fee schedule requiring a subscription plus a fee for each advertisement, limiting the consumer's access to the advertisement, and how prominently to feature the advertisement (e.g., when sending the advertisement to a consumer, placing the advertisement first in the list of advertisements). The vendor advertisement must carry information sufficient to permit a consumer agent to contact the vendor (e.g. Its agent locator or its name or other key for lookup in the directory service). Matchmakers may also place additional restrictions on vendor advertisements, such as, for example, requiring the vendors to identify their offering(s) in the matchmaker's ontology of services or goods and restricting the number and/or type of services offered. Matchmakers may also permit advertisements to carry free-form information.

Once vendor advertisements have been received, upon request from a consumer agent, the matchmaker provides the consumer agent with information about the available services (step 710). This information may be made available to any agent for free or for a per use fee or only to subscribers. This information may be provided to the consumer agent, for example, by making searches available, allowing browsing of categories, or providing the list for download.

Also upon request, the matchmaker provides consumer agents with information about vendor listings matching specified search criteria, such as, for example category names, keyword search terms for goods and services, or keyword search terms to apply to other portions of vendor listings (step 709). This information may consist of extracts of vendors' listings, summary information such as the number of vendor listings matching the search criteria, or other information. However, in the case where the matchmaker is charging a fee for providing vendor information to consumers, it should not contain agent locators or other information that would permit the consumer agent to immediately contact vendors.

Also upon request, the matchmaker provides consumer agents with a set of vendor listings (step 708). This set of vendor listings may be provided for free to any consumer agent, for a per use fee to any consumer agent, or only to subscribing consumers, thus requiring non-subscribing consumers to subscribe before providing the list. Alternatively, the matchmaker may provide partial information about the ads for free, and charge for the remainder of it; for example, it may require payment before releasing the vendors' agent locators. Other variations allow consumers access to lists via subscription plus a usage fee. Alternatively, the matchmaker may charge the vendor whose listing is provided. Other fee schedules may be utilized as well. The consumer may specify the selection criteria for desired vendor listings after receiving information about available services as provided in step 710 or, if the selection criteria are already known, select the vendor listings without the aid of the information provided in step 710. Matchmakers may provide subsets of the listings in a category or matching a search criterion, for example, for a reduced fee. Subscriptions may follow any subscription model such as, for example, flat fee, usage based, or multi-tiered.

The consumer may search the received listings by category, by name, or by other fields before selecting a vendor or vendors from which to request a quote. The listing format may include service or goods description information plus other interoperability in formation such as, for example, preferred or supported interaction protocols and payment methods.

Although the present invention has been described primarily in terms of fixed fees and a minimum of negotiations between agents, the present invention is not limited to such cases. For example, each of the different categories of agents may conduct negotiations with other agents as to fee and other conditions and terms related to use of the matchmaker service or to the sale or purchase of goods or services. These negotiations may be performed by each agent with a minimum or no human owner interaction. The agent may use conditions, terms, prices previously specified by its human owner to conduct the negotiation process. Thus, for example, a human owner of a consumer agent may specify an initial bid to offer for a specific type of item. This initial bid may be a variable initial bid that depends on the condition of the product offered for sale or other terms associated with the product. The consumer agent may then adjust the offer price up to a maximum price depending on the responses received from the vendor agent. Thus, if the vendor agent accepts the initial bid price, the consumer agent would not need to offer more money, thereby saving the human owner of the consumer agent some money. Other variations and options will be apparent to one of ordinary skill in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of exchanging goods and services in a non-centralized exchange system; the method comprising:
registering, by a matchmaker, with at least one of a plurality of directory services;
receiving, at a matchmaker, advertisements from a plurality of vendor agents, wherein the plurality of vendor agents obtained the identity and contact information of the matchmaker from the at least one of a plurality of directory services and wherein the advertisements comprise an informational format designated by the matchmaker;
obtaining, by a consumer agent, the identity and the contact information about the matchmaker from the at least one directory service;
receiving, at the consumer agent, a consumer agent selected list of advertisements from the matchmaker, wherein the each advertisement in the selected list of advertisements match criteria specified by the consumer agent;
sending, from the consumer agent, a request for a quote to one or more of the vendor agents corresponding to advertisements in the consumer agent selected list of advertisements; and
receiving, by the consumer agent, responses from the one or more vendor agents.

2. The method as recited in claim 1, further comprising:
completing a purchase of a product from a selected one of the one or more vendor agents replying with an offer for sale.

3. The method as recited in claim 1, wherein the consumer agent selected list of advertisements is provided to the consumer agent for a fee.

4. The method as recited in claim 3, wherein the fee includes a subscription fee to the matchmaker service.

5. The method as recited in claim 3, wherein the fee includes a fee per list of advertisements provided to the consumer agent by the matchmaker.

6. The method as recited in claim 1, wherein the matchmaker charges a fee to each of the plurality of vendor agents for listing the advertisements with the matchmaker service.

7. The method as recited in claim 6, wherein the fee includes a subscription fee.

8. The method as recited in claim 6, wherein the fee includes a fee per advertisement listed with the matchmaker.

9. A method of matching consumers with vendors, the method comprising:
listing a matchmaking service with one or more of a plurality of directory services, wherein each of the plurality of directory services contains contact information for matchmaking services;
receiving and carrying advertisements from one or more vendor agents, wherein the one or more vendor agents locate the matchmaking service using the one or more of a plurality of directory services with which the matchmaking service is listed and wherein the advertisements conform to a format dictated by the matchmaking service; and
responsive to a request from a consumer agent, providing a consumer agent with vendor information.

10. The method as recited in claim 9, further comprising:
organizing the advertisements into categories.

11. The method as recited in claim 9, wherein the vendor information includes vendors listings.

12. The method as recited in claim 9, wherein the vendor information includes information about available products.

13. The method as recited in claim 12, wherein the available products include goods.

14. The method as recited in claim 12, wherein the available products include services.

15. The method as recited in claim 9, wherein the vendor information includes contact information for vendors.

16. The method as recited in claim 15, wherein the contact information is provided for a fee.

17. The method as recited in claim 9, wherein the vendor information includes a list of advertisements matching criteria supplied by the consumer.

18. The method as recited in claim 10, wherein the criteria includes a category.

19. The method as recited in claim 9, wherein the criteria includes at least one keyword search term.

20. The method as recited in claim 9, wherein the criteria includes a selection based upon browsing through listings.

21. The method as recited in claim 9, wherein the criteria includes similarity to a selected listing.

22. The method as recited in claim 9, wherein a fee is charged to the consumer agent for providing the list of advertisements sent to the consumer agent.

23. The method as recited in claim 22, wherein the fee includes a subscription fee to the matchmaker service.

24. The method as recited in claim 22, wherein the fee includes a fee per list provided by the matchmaker.

25. The method as recited in claim 9, wherein a fee is charged to the vendor agents for carrying the advertisements.

26. The method as recited in claim 25, wherein the fee includes a subscription fee.

27. The method as recited in claim 25, wherein the fee includes a fee per advertisement listed with the matchmaker.

28. The method as recited in claim 9, wherein the advertisements are carried for a limited time.

29. The method as recited in claim 9, wherein some of the advertisements are be placed in a position of prominence within a category list in response to receipt of a payment of a premium fee.

30. The method as recited in claim 9, wherein the consumer agent selects the requested category after browsing a category listing provided by the matchmaker.

31. The method as recited in claim 9, wherein the consumer agent selects the requested category using a keyword search over the advertisements.

32. the method as recited in claim 9, wherein the consumer agent selects the requested category based on the similarity to other selected advertisements.

33. The method as recited in claim 9, wherein the consumer agent selects the requested category after searching a category listing provided by the matchmaker.

34. A method for a consumer to locate one or more vendors of a product, the method comprising:
finding contact information for one or more matchmakers from a directory service; and
requesting and receiving from at least one matchmaker a vendor information for a particular category of products.

35. The method as recited in claim 34, wherein the vendor information includes contact information for each vendor.

36. The method as recited in claim 34, further comprising:
requesting a quote from one or more vendors on the list of vendors.

37. The method as recited in claim 38, further comprising:
completing a purchase for a product with a selected one of the vendors supplying a quote for the product.

38. The method as recited in claim 34, wherein the list of vendors for a particular category of products requested by the consumer agent is selected after a search of available product categories from the matchmaker.

39. The method as recited in claim 34, wherein the list of vendors for a particular category of products requested by the consumer agent is selected after browsing a listing of categories available from the matchmaker.

40. The method as recited in claim 34, wherein the list of vendors for a particular category of products requested by the consumer agent is selected using at least one keyword search term.

41. The method as recited in claim 34, wherein the list of vendors for a particular category of products requested by the consumer agent is selected based on a similarity to a selected listing.

42. A method of selling products, the method comprising:
identifying a matchmaker using at least one of a plurality of directory services containing contact information for one or more matchmakers, wherein at least one directory service contains a different set of matchmakers from at least one other directory service;
contacting the matchmaker and obtaining advertisement content and format requirements;
creating an advertisement complying with advertisement content and format requirements for the matchmaker; and
providing the advertisement to the matchmaker.

43. The method as recited in claim 42, further comprising:
providing the matchmaker with a preferred presentation of the advertisement.

44. The method as recited in claim 43, wherein the preferred presentation of the advertisement comprises a preferred placement of the advertisement in a list of advertisements provided to consumer agents.

45. A computer program product in a computer readable media for use in a data processing system for exchanging goods and services in a non-centralized exchange system; the computer program product comprising:
first instructions for registering, by a matchmaker, with at least one of a plurality of directory services;
second instructions for receiving, at a matchmaker, advertisements from a plurality of vendor agents, wherein the plurality of vendor agents obtained the identity and contact information of the matchmaker from the at least one of a plurality of directory services and wherein the advertisements comprise an informational format designated by the matchmaker;
third instructions for obtaining, by a consumer agent, the identity and the contact information about the matchmaker from the at least one directory service;
fourth instructions for receiving, at the consumer agent, a consumer agent selected list of advertisements from the matchmaker, wherein the each advertisement in the selected list of advertisements match criteria specified by the consumer agent;
fifth instructions for sending, from the consumer agent, a request for a quote to one or more of the vendor agents corresponding to advertisements in the consumer agent selected list of advertisements; and
sixth instructions for receiving, by the consumer agent, responses from the one or more vendor agents.

46. The computer program product as recited in claim 45, further comprising:
seventh instructions for completing a purchase of a product from a selected one of the one or more vendor agents replying with an offer for sale.

47. The computer program product as recited in claim 45, wherein the consumer agent selected list of advertisements is provided to the consumer agent for a fee.

48. The computer program product as recited in claim 47, wherein the fee includes a subscription fee to the matchmaker service.

49. The computer program product as recited in claim 47, wherein the fee includes a fee per List of advertisements provided to the consumer agent by the matchmaker.

50. The computer program product as recited in claim 45, wherein the matchmaker charges a fee to each of the plurality of vendor agents for listing the advertisements with the matchmaker service.

51. The computer program product as recited in claim 50, wherein the fee includes a subscription fee.

52. The computer program product as recited in claim 50, wherein the fee includes a fee per advertisement listed with the matchmaker.

53. A computer program product in a computer readable media for use in a data processing system for matching consumers with vendors, the computer program product comprising:
first instructions for listing a matchmaking service with one or more of a plurality of directory services, wherein each of the plurality of directory services contains contact information for matchmaking services;
second instructions for receiving and carrying advertisements from one or more vendor agents, wherein the one or more vendor agents locate the matchmaking service using the one or more of a plurality of directory services with which the matchmaking service is listed and wherein the advertisements conform to a format dictated by the matchmaking service; and
third instructions, responsive to a request from a consumer agent, for providing a consumer agent with vendor information.

54. The computer program product as recited in claim 53, further comprising:
fourth instructions for organizing the advertisements into categories.

55. The computer program product as recited in claim 53, wherein the vendor information includes vendors listings.

56. The computer program product as recited in claim 53, wherein the vendor information includes information about available products.

57. The computer program product as recited in claim 56, wherein the available products include goods.

58. The computer program product as recited in claim 56, wherein the available products include services.

59. The computer program product as recited in claim 53, wherein the vendor information includes contact information for vendors.

60. The computer program product as recited in claim 59, wherein the contact information is provided for a fee.

61. The computer program product as recited in claim 53, wherein the vendor information includes a list of advertisements matching criteria supplied by the consumer.

62. The computer program product as recited in claim 54, wherein the criteria includes a category.

63. The computer program product as recited in claim 53, wherein the criteria includes at least one keyword search term.

64. The computer program product as recited in claim 53, wherein the criteria includes a selection based upon browsing through listings.

65. The computer program product as recited in claim 53, wherein the criteria includes similarity to a selected listing.

66. The computer program product as recited in claim 53, wherein a fee is charged to the consumer agent for providing the list of advertisements sent to the consumer agent.

67. The computer program product as recited in claim 66, wherein the fee includes a subscription fee to the matchmaker service.

68. The computer program product as recited in claim 66, wherein the fee includes a fee per list provided by the matchmaker.

69. The computer program product as recited in claim 53, wherein a fee is charged to the vendor agents for carrying the advertisements.

70. The computer program product as recited in claim 69, wherein the fee includes a subscription fee.

71. The computer program product as recited in claim 69, wherein the fee includes a fee per advertisement listed with the matchmaker.

72. The computer program product as recited in claim 53, wherein the advertisements are carried for a limited time.

73. The computer program product as recited in claim 53, wherein some of the advertisements are be placed in a position of prominence within a category list in response to receipt of a payment of a premium fee.

74. The computer program product as recited in claim 53, wherein the consumer agent selects the requested category after browsing a category listing provided by the matchmaker.

75. The computer program product as recited in claim 53, wherein the consumer agent selects the requested category using a keyword search over the advertisements.

76. the computer program product as recited in claim 53, wherein the consumer agent selects the requested category based on the similarity to other selected advertisements.

77. The computer program product as recited in claim 53, wherein the consumer agent selects the requested category after searching a category listing provided by the matchmaker.

78. A computer program product in a computer readable media for use in a data processing system for a consumer to locate one or more vendors of a product, the computer program product comprising:
first instructions for finding contact information for one or more matchmakers from a directory service; and
second instructions for requesting and receiving from at least one matchmaker vendor information for a particular category of products.

79. The computer program product as recited in claim 78, wherein the vendor information includes contact information for each vendor.

80. The computer program product as recited in claim 78, further comprising:
third instructions for requesting a quote from one or more vendors on the list of vendors.

81. The computer program product as recited in claim 80, further comprising:
fourth instructions for completing a purchase for a product with a selected one of the vendors supplying a quote for the product.

82. The computer program product as recited in claim 78, wherein the vendor information includes a list of vendors for a particular category of products requested by the consumer agent the list of vendors is selected after a search of available product categories from the matchmaker.

83. The computer program product as recited in claim 78, wherein the vendor information includes a list of vendors for a particular category of products requested by the consumer agent the list of vendors is selected after browsing a listing of categories available from the matchmaker.

84. The computer program product as recited in claim 78, wherein the vendor information includes a list of vendors for a particular category of products requested by the consumer agent the list of vendors is selected using at least one keyword search term.

85. The computer program product as recited in claim 78, wherein the vendor information includes a list of vendors for a particular category of products requested by the consumer agent the list of vendors is selected based on a similarity to a selected listing.

86. A computer program product in a computer readable media for use in a data processing system for selling products, the computer program product comprising:
first instructions for identifying a matchmaker using at least one of a plurality of directory services containing contact information for one or more matchmakers, wherein at least one directory service contains a different set of matchmakers from at least one other directory service;
second instructions for contacting the matchmaker and obtaining advertisement content and format requirements;
third instructions for creating an advertisement complying with advertisement content and format requirements for the matchmaker; and
fourth instructions for providing the advertisement to the matchmaker.

87. The computer program product as recited in claim 86, further comprising:
fifth instructions for providing the matchmaker with a preferred presentation of the advertisement.

88. The computer program product as recited in claim 87, wherein the preferred presentation of the advertisement comprises a preferred placement of the advertisement in a list of advertisements provided to consumer agents.

89. A system for exchanging goods and services in a non-centralized exchange system; the system comprising:
a first component in a matchmaker which registers with at least one of a plurality of directory services;
a second component in the matchmaker which receives advertisements from a plurality of vendor agents, wherein the plurality of vendor agents obtain the identity and contact information of the matchmaker from the at least one of a plurality of directory services and wherein the advertisements comprise an informational format designated by the matchmaker;
a third component in a consumer agent which obtains the identity and the contact information about the matchmaker from the at least one directory service;
a fourth component in the consumer agent which receives consumer agent selected list of advertisements from the matchmaker, wherein the each advertisement in the selected list of advertisements match criteria specified by the consumer agent;
a fifth component in the consumer agent which sends a request for a quote to one or more of the vendor agents corresponding to advertisements in the consumer agent selected list of advertisements; and
a sixth component in the consumer agent which receives responses from the one or more vendor agents.

90. The system as recited in claim 89, further comprising:
a seventh component in the consumer agent which completes a purchase of a product from a selected one of the one or more vendor agents replying with an offer for sale.

91. The system as recited in claim 89, wherein the consumer agent selected list of advertisements is provided to the consumer agent for a fee.

92. The system as recited in claim 91, wherein the fee includes a subscription fee to the matchmaker service.

93. The system as recited in claim 91, wherein the fee includes a fee per list of advertisements provided to the consumer agent by the matchmaker.

94. The system as recited in claim 89, wherein the matchmaker charges a fee to each of the plurality of vendor agents for listing the advertisements with the matchmaker service.

95. The system as recited in claim 94, wherein the fee includes a subscription fee.

96. The system as recited in claim 94, wherein the fee includes a fee per advertisement listed with the matchmaker.

97. A system for matching consumers with vendors, the system comprising:
a first component which lists a matchmaking service with one or more of a plurality of directory services, wherein each of the plurality of directory services contains contact information for matchmaking services;
a second component which receives and carries advertisements from one or more vendor agents, wherein the one or more vendor agents locate the matchmaking service using the one or more of a plurality of directory services with which the matchmaking service is listed and wherein the advertisements conform to a format dictated by the matchmaking service; and
a third component which, responsive to a request from a consumer agent, provides a consumer agent with vendor information.

98. The system as recited in claim 97, further comprising:
a fourth component which organizes the advertisements into categories.

99. The system as recited in claim 97, wherein the vendor information includes vendors listings.

100. The system as recited in claim 97, wherein the vendor information includes information about available products.

101. The system as recited in claim 100, wherein the available products include goods.

102. The system as recited in claim 100, wherein the available products include services.

103. The system as recited in claim 97, wherein the vendor information includes contact information for vendors.

104. The system as recited in claim 103, wherein the contact information is provided for a fee.

105. The system as recited in claim 97, wherein the vendor information includes a list of advertisements matching criteria supplied by the consumer.

106. The system as recited in claim 98, wherein the criteria includes a category.

107. The system as recited in claim 97, wherein the criteria includes at least one keyword search term.

108. The system as recited in claim 97, wherein the criteria includes a selection based upon browsing through listings.

109. The system as recited in claim 97, wherein the criteria includes similarity to a selected listing.

110. The system as recited in claim 97, wherein a fee is charged to the consumer agent for providing the list of advertisements sent to the consumer agent.

111. The system as recited in claim 110, wherein the fee includes a subscription fee to the matchmaker service.

112. The system as recited in claim 110, wherein the fee includes a fee per list provided by the matchmaker.

113. The system as recited in claim 97, wherein a fee is charged to the vendor agents for carrying the advertisements.

114. The system as recited in claim 113, wherein the fee includes a subscription fee.

115. The system as recited in claim 113, wherein the fee includes a fee per advertisement listed with the matchmaker.

116. The system as recited in claim 97, wherein the advertisements are carried for a limited time.

117. The system as recited in claim 97, wherein some of the advertisements are be placed in a position of prominence within a category list in response to receipt of a payment of a premium fee.

118. The system as recited in claim 97, wherein the consumer agent selects the requested category after browsing a category listing provided by the matchmaker.

119. The system as recited in claim 97, wherein the consumer agent selects the requested category using a keyword search over the advertisements.

120. the system as recited in claim 97, wherein the consumer agent selects the requested category based on the similarity to other selected advertisements.

121. The system as recited in claim 97, wherein the consumer agent selects the requested category after searching a category listing provided by the matchmaker.

122. A system for a consumer to locate one or more vendors of a product, the system comprising:
a first component which finds contact information for one or more matchmakers from a directory service; and
a second component which requests and receives from at least one matchmaker vendor information for a particular category of products.

123. The system as recited in claim 122, wherein the vendor information includes contact information for each vendor.

124. The system as recited in claim 122, further comprising:
a third component which requests a quote from one or more vendors on the list of vendors.

125. The system as recited in claim 124, further comprising:
a fourth component which completes a purchase for a product with a selected one of the vendors supplying a quote for the product.

126. The system as recited in claim 122, wherein the vendor information includes a list of vendors for a particular category of products requested by the consumer agent and the list of vendors is selected after a search of available product categories from the matchmaker.

127. The system as recited in claim 122, wherein the vendor information includes a list of vendors for a particular category of products requested by the consumer agent and the list of vendors is selected after browsing a listing of categories available from the matchmaker.

128. The system as recited in claim 122, wherein the vendor information includes a list of vendors for a particular category of products requested by the consumer agent and the list of vendors is selected using at least one keyword search term.

129. The system as recited in claim 122, wherein the vendor information includes a list of vendors for a particular category of products requested by the consumer agent the list of vendors is selected based on a similarity to a selected listing.

130. A system for selling products, the system comprising:
a first component which identifies a matchmaker using at least one of a plurality of directory services containing contact information for one or more matchmakers, wherein at least one directory service contains a different set of matchmakers from at least one other directory service;
a second component which contacts the matchmaker and obtains advertisement content and format requirements;
a third component which creates an advertisement complying with advertisement content and format requirements for the matchmaker; and
a fourth component which provides the advertisement to the matchmaker.

131. The system as recited in claim 130, further comprising:
a fifth component which provides the matchmaker with a preferred presentation of the advertisement.

132. The system as recited in claim 131, wherein the preferred presentation of the advertisement comprises a preferred placement of the advertisement in a list of advertisements provided to consumer agents.
